(19) United States
(12) Patent Application Publication
(10) Pub. No.: US 2023/0182147 A1
(43) Pub. Date: Jun. 15, 2023

(54) MACHINE AND METHOD FOR SHREDDING INORGANIC WASTE

(71) Applicant: Frieco Societa' Benefit S.R.L., Milano (IT)

(72) Inventors: Roberto Frisina, Milano (IT); Danilo Frisina, Milano (IT)

(21) Appl. No.: 17/926,445

(22) PCT Filed: Apr. 9, 2021
(86) PCT No.: PCT/IT2021/050100

§ 371 Date: Nov. 18, 2022

(30) Foreign Application Priority Data
May 20, 2020 (IT) 102020000011764

(51) Int. Cl. B02C 25/00; B02C 18/22; B02C 18/24; B02C 18/14; B09B 3/35

(52) U.S. Cl. CPC B02C 25/00; B02C 18/24; B02C 18/142; B02C 18/2291; B09B 3/35; B02C 2018/164

(57) ABSTRACT

A machine for shredding inorganic waste is described, comprising: first loading means; a shredding chamber; second shredding means; third unloading means; fourth electronic control means; fifth means for limiting the resisting torque applied to the motor, in such a way as to avoid current absorption that exceeds the capacity of the power supply network, said fifth means comprising one or more mobile elementsand a plurality of blades. A method for operating the machine is also described.

The present invention relates to a machine and a method for shredding inorganic waste with low power absorption. For inorganic waste we mean, for example, containers or packaging made of plastic, glass, metals, paper or cardboard, etc.

Various systems for the volumetric reduction of inorganic waste are known which are often used in industries or in recycling plants.

In particular, there are two different technologies: compaction and shredding.

The compaction is carried out substantially by crushing, by means of rollers or hydraulic presses, the material to be treated, thus obtaining a percentage of volumetric reduction that hardly exceeds 60%; furthermore, the resulting product does not facilitate or in any case make the recycling chain that must be carried out in order to recover the material longer.

Shredding, on the other hand, allows to obtain a much greater volumetric reduction, even over 90%. It is generally performed through the use of double/single/square shaft shredders with opposing blades, rotating in the opposite direction, or through the use of fixed blades and rotating blades.

The resulting material will in this case be composed of small fragments which, through the use of appropriate technologies, can make the recycling chain shorter.

These machines are therefore able to reduce the volume of inorganic waste.

However, the shredding performed with the methods indicated above presents several critical issues which are mainly safety, noise, the high cost of construction and maintenance of the machines, the high shredding time, the possibility of jamming whose resolution requires rotation in the opposite direction. of the motor, the large dimensions of the machines themselves and the powers necessary for operation, which are in the order of tens of kW.

In industrial contexts the aforementioned criticalities can be negligible, or solved in different ways such as, for example, in the case of safety, where large hoppers and material insertion ducts are used, built in a particular way to prevent the staff from reaching the blades. of shredding.

Another aspect of the problem consists in the fact that the volume reduction operation by means of shredding plants is usually performed on the place where the recycling process is carried out. The waste materials as such are withdrawn from the streets, homes or various commercial activities and transported to the places where the treatments are carried out.

There are also other equipment for use in the vending sector or installed on public land or on commercial activities that allow the volumetric reduction of waste through the methods described above (compaction or shredding) which have other limits such as the possibility of treating a single type. waste (plastic only, glass only), or the possibility of inserting only bottles, one bottle at a time, maximum half-liter bottles or just coffee glasses.

In the case of machines to be installed in domestic users, the main limit, in addition to those indicated above, seems to be that of excessive current absorption, even in very small machines.

Object of the present invention is solving at least in part the aforesaid problems of the prior art, by providing a machine and a method for shredding inorganic waste, said machine being driven by an electric motor.

An object is to strongly limit the absorption of electrical power from the network, so that it can also be used in domestic users.

Another object is to provide safety systems which allow their safe use even by non-specialized persons.

The aforesaid and other objects and advantages of the invention, as will emerge from the following description, are achieved with a machine, according to claim 1, suitable for reducing the volume of inorganic waste by means of shredding, and a method, according to claim 13, adapted to allow the operation of said machine by limiting its absorption of electrical energy.

The machine is of the type comprising:
first loading means, suitable for receiving the materials to be shredded and pouring them into a shredding chamber;
   second shredding means, driven by a motor, suitable for shredding the materials introduced;
   third unloading means, suitable for collecting the shredded materials;
   fourth electronic means of controlling the operation of the machine;
and is characterized in that it provides fifth means, controlled by said fourth electronic means, suitable for limiting the resisting torque applied to said motor, in such a way as to avoid current absorption that exceeds the capacity of the power supply network.

Said fifth means, adapted to limit the resisting torque applied to said motor, comprise, alternatively or both:
one or more mobile elements, able to assume positions that allow the introduced materials to be gradually poured into the shredding chamber, so that the engine can be started empty or with minimum load;
a plurality of knives which interact with each other to carry out the shredding of the materials introduced, said interaction being controlled in order to avoid excessive accumulations of material between said knives, so that the resistant couple, due to the cutting action, does not generate absorption of current, from the motor, higher than the capacity of the power supply network.

The method for limiting the power necessary to operate said shredding machine for inorganic materials, is characterized by limiting the development of resistant couples, due to the shredding action, which require current absorption that exceeds the capacity of the network. supply.

Said limitation of the development of resistant couples, due to the shredding action, is implemented:
through a gradual pouring of the materials to be treated into said shredding chamber, allowing the engine to start with no load or with minimum load, said gradualness being obtained by a gradual rotation of said mobile element controlled by said fourth electronic means;
through an intervention aimed at controlling any excessive accumulation of materials on said shredding means.

As will be seen in the following description of an application example, the technological limitations and drawbacks of the prior art are overcome, as the invention creates a machine with industrial performance but with dimensions and even domestic usability.

Preferred embodiments and non-trivial variants of the present invention form the subject of the dependent claims.

With a machine conforming to the invention, a real reduction of 85 ÷ 95% is obtained, in fact the scale cannot leave the grinding chamber until it reaches the predetermined size (about 1 cm).

Other advantages of the machine according to the invention are increased safety and a reduction in operating noise. Furthermore, the cost of production and maintenance is reduced, the shredding speed increases, the mechanism is avoided, it is possible to insert more waste at the same time with different types of waste, even large containers or packaging of various kinds. also flexible up to bags or whole bags.

This machine can be used both in the home and in commercial or industrial activities, appropriately scaling the size according to the customer’s needs, thus introducing, within the recycling chain, the concept of volumetric reduction at the source, thus facilitating other recycling processes with a view to localized circular economy.

The repercussions in terms of environmental benefit are also of considerable importance, given by the lower pollution of the means of transport circulating on the roads, due to the fact that the volume reduction would be carried out before the transport itself.

It is understood that all the attached claims form an integral part of the present description.

It will be immediately obvious that innumerable variations and modifications (for example relating to shape, dimensions, arrangements and parts with equivalent functionality) can be made to what has been described without departing from the scope of the invention as appears from the attached claims.

The present invention will be better described by a preferred embodiment, provided by way of nonlimiting example, with reference to the attached drawings, in which:

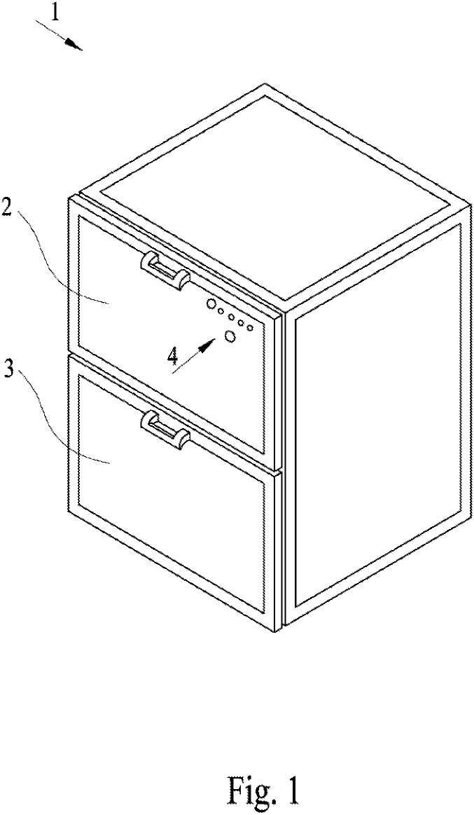

FIG. 1 is a perspective view of the machine according to the invention;

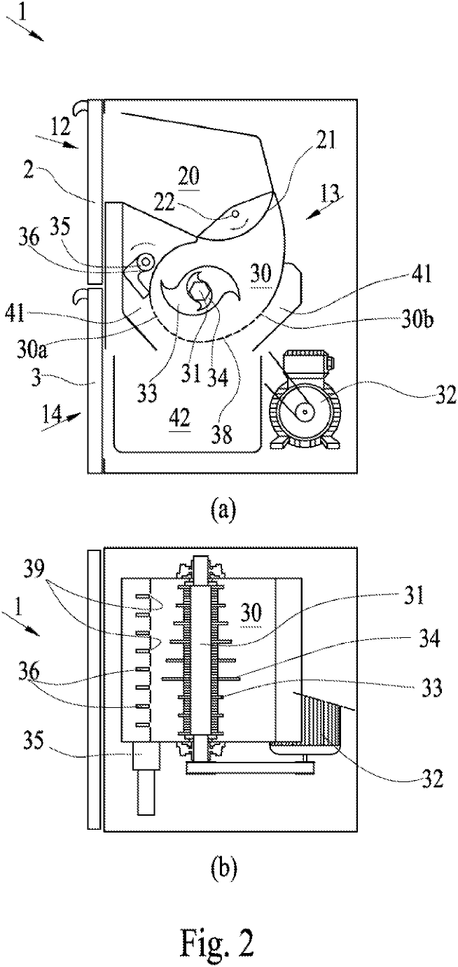

FIG. 2 (a, b) are a diagram of the inside of the machine, according to a vertical and a horizontal plane passing through the axis of the knife holder rotor;

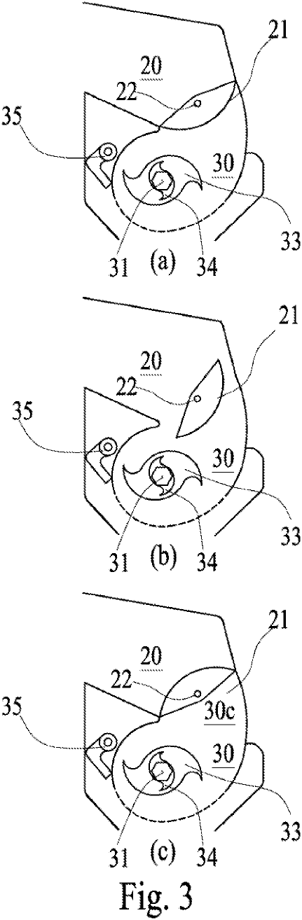

FIG. 3 (a, b, c) show three configurations of the loading system for the materials to be treated.

With reference to FIGS. 1 and 2, (1) designates a machine for shredding inorganic materials according to the invention.

According to a preferred embodiment, said machine (1) has compact dimensions and a design suitable for a home installation or in small commercial or artisan businesses, in which solid inorganic waste is produced.

The machine (1) is equipped with:
an upper opening, closed by a first door (2), which allows the introduction of the materials to be shredded;
a lower opening, closed by a second door (3), from which the shredded materials are extracted;
a small control panel (4), positioned on the upper door (2), designed to signal the status of the machine (1) and any malfunctions as well as allowing the start-up and selection of the work cycle.

Both doors (2, 3) are equipped with an electric lock (not shown) that keeps them closed during the operation of the machine (1).

Said machine (1) includes:
first loading means (12), suitable for receiving the materials to be shredded;
second shredding means (13), suitable for shredding the introduced materials;
third unloading means (14), suitable for collecting the shredded materials;
fourth electronic control means (not shown) designed to regulate the operation of the machine;
fifth means, controlled by said fourth electronic means, suitable for limiting the resistant torque due to shredding.

These fifth means include:
one or more mobile elements (21), able to assume positions that allow the introduced materials to be gradually poured into the shredding chamber (30);
a plurality of knives (33, 34, 36) which interact with each other to effect the shredding of the materials introduced.

The way the fifth means work will be clarified in the following.

Said first loading means (12) comprise said first door (2) which allows access to a large area (20), in which there is a sensor (not shown), to detect the presence of materials to be treated, said the loading area (20) being limited downwards by a movable element (21), rotatable around a pin (22), which has the main function of regulating the flow of the materials to be treated.

According to a preferred embodiment, the element (21) has the sectional shape of an arc of circumference. This allows it to accommodate the materials to be treated in the concavity and to pour them easily into an underlying shredding chamber (30) by rotating around said pin (22).

According to another preferred embodiment, said mobile element (21) can be replaced by multiple mobile elements (not shown) designed to open the passage between the loading area (20) and the shredding chamber (30).

This and other functions of the mobile element (21) will be better specified below.

Said second shredding means (13) comprise:
a shredding chamber (30), in which there is preferably a filling sensor (not shown), inside which there is a single shaft main rotor (31), driven by an electric motor (32), on said rotor main (31) being mounted a first series of larger knives (33) interspersed with a second series of minor knives (34), having shapes and distances suitable for shredding and dragging, avoiding the ball effect on said single shaft main rotor (31));
a rake (35) on which a third series of major knives (36) is mounted, possibly interspersed with a fourth series of minor knives (not shown), said knives (36) of the rake (35) interacting with said knives (33, 34) of the main rotor (31).

The wall of said shredding chamber (30), made of wear-resistant steel, comprises:
a first section (30a), substantially circular in shape and having a center on the axis of said main rotor (31);
a second section (30b), which is connected with said first section (30a), of a substantially circular shape, but with a greater radius than the previous one so as to increase the distance between the trajectory of the ends of the blades (33) and the wall of the shredding chamber (30);
said movable element (21) which rotates around the pin (22) so as to open/close the passage between said loading area (20) and said shredding chamber (30).

In the lower part of the wall of the shredding chamber (30) a plurality of openings is made, so as to obtain a sort of evacuation net (38), suitable for letting the shredded material through, acting as a sieve that allows only the fragments that have reached a predetermined size, said openings being able to have various shapes (for example round, square, etc.) and dimensions.

The rake (35) is placed outside the shredding chamber (30), in correspondence with the main rotor (31) in order to interact with it. Said interaction occurs following a rotation of said rake (35) towards the main rotor (31) and the consequent insertion of the blades (36) of the rake (35) between the knives (33, 34) of the main rotor (31). Said insertion is made possible by suitable openings (39) made on the wall of the shredding chamber (30).

Alternatively, the rake (35) can be placed inside the shredding chamber (30); in this case said minor knives are present (not shown) and no openings are necessary in the wall of said shredding chamber to allow the knives (36) of the rake (35) to pass.

Furthermore, on the rake (35) there are sensors, able to identify both its position with respect to the main rotor (31), and the presence of any loads interposed in the movement that excessively hinder its rotation, causing an increase in the absorption of incompatible electrical power. with the capacity of the power supply network.

Said mobile element (21) can assume various positions, rotating around said pin (22):
a first position, shown in FIG. 3a, in which the mobile element (21) has the concavity facing upwards and completely closes the passage between the loading area (20) and the shredding chamber (30) ;
a second position, shown in FIG. 3b, in which the mobile element (21) opens the passage between the loading area (20) and the shredding chamber (30), allowing the loaded material to enter the shredding chamber (30), the passage from said first position to said second position being able to take place gradually; this will allow a progressive increase of the load on the shredding knives avoiding both too high starting torques, an excessive load of materials, and a block of the rotor (31), requiring high electrical power absorbed by the network; the rotation of the mobile element (21) is also a function of the size of the materials to be loaded, in fact by increasing the angle of rotation, the area of the passage section also increases;
a third position, shown in FIG. 3c, in which the mobile element (21) rotates by 180°, completely closing the passage towards the loading area (20) and delimiting a large area (30c), inside the shredding chamber (30), in to which the materials projected by the centrifugal force, consequent to the strong rotation imparted by the main rotor (31), tend to accumulate dynamically; in practice, the materials partially shredded and projected by the centrifugal force tend to accumulate in the area (30c) of the shredding chamber (30), falling by gravity into the area below where they are hooked again by the knives (33, 34) of the main rotor (31) to pass between the knives (36) of the rake (35) and undergo a new shredding.

In addition to the functions described, said movable element (21) also has an important safety function, as it prevents access by hand to the shredding chamber (30) since the deposition of the materials in the loading area (20) takes place with the mobile element (21) in the closed position.

Furthermore, the mobile element (21) reduces the noise since, after the total discharge of the material present in the loading area (20) into the shredding chamber (30), it is arranged according to said third position so as to avoid the return of flakes towards the inlet and, being provided with suitable seals, also reduces the noise generated by crushing.

According to a preferred embodiment, the installation, inside the shredding chamber (30), of a suction system (not shown) of the dust that is generated in the shredding of some materials is provided.

Said third unloading means (14), for the collection of the shredded materials, comprise a jacket conveyor (41), positioned outside the shredding chamber (30). Said conveyor (41) is shaped in such a way as to receive the shredded material that comes out of the evacuation net (38) and to convey it towards a collection area, where a basket (42) is positioned. A level sensor (not shown) is positioned in the jacket (41) or in the basket (42) to detect the filling of the basket itself, to signal its status to an electronic control system.

There are also said fourth electronic means (not shown) able to receive signals from the various sensors in order to control the operation of the machine (1) and to emit alarm signals in case of malfunctions.

The operation of the machine (1), by implementing this method for limiting the absorption of electricity, is as follows.

After opening the upper door (2), the operator places the materials to be shredded in the loading area (20). These materials are collected in the concavity of the mobile element (21) (FIG. 3a). After loading, the upper door (2) is closed and the electric locks of both doors (2, 3) are activated. The mobile element (21) rotates gradually, preferably after the motor (32) has already been started with no load, in order to limit the current absorption at start-up. The rotation of the mobile element (21) around the pin (22) allows to open the passage between the loading area (20) and the shredding chamber (30), said rotation taking place with the necessary gradualness to avoid a too rapid insertion of the materials to be shredded. In this way, the power required by the system is limited and the use of lower power motors is made possible and, therefore, able to operate with the low electrical power installed in domestic users.

The material falling into the shredding chamber (30) is thrown by the knives (33, 34) of the main rotor (31) against the walls of the shredding chamber (30) itself. Driven by the rotation of the knives, the material circulates inside the shredding chamber (30) with a circular trajectory around the axis of the main rotor (31), passing several times between the blades of the main rotor (31) and those of the rake (35), breaking up further at each step. The circular trajectory causes it to be projected by centrifugal force against the walls of the shredding chamber (30); this fact allows the formation of said dynamic accumulation in the area (30a) of the shredding chamber (30) and facilitates the exit through the evacuation network (38), when the fragments have reached the desired size.

1. Machine for shredding inorganic waste, of the type comprising:
first loading means, suitable for receiving the materials to be shredded and for pouring them into a shredding chamber;
second shredding means, driven by a motor, suitable for shredding the introduced materials;
third unloading means, suitable for collecting the shredded materials;
fourth electronic means of controlling the operation of the machine;
fifth means, controlled by said fourth electronic means, adapted to limit the resisting torque applied to said motor, in such a way as to avoid current absorption that exceeds the capacity of the power supply network, said fifth means comprising one or more elements movable, adapted to assume positions that allow the introduced materials to be gradually poured into the shredding chamber, so that the motor can be started empty or with minimum load, said fifth means further comprising a plurality of knives which interact with each other to carry out the shredding of the materials introduced, said interaction being controlled in order to avoid excessive accumulations of material between said knives so as to prevent the resistant torque, due to the cutting action, generates current absorption by the motor higher than the capacity of the power supply network;
characterized in that said second shredding means comprise said shredding chamber in which there is a main rotor, driven by a motor and provided with a plurality of knives which interact with the knives of a rake, said rake being movable to bring said knives to interact with said knives of said main rotor, the position of said rake with respect to said main rotor being adjustable so as to check that the resistant torque due to the cutting action of the knives generates current absorption by the motor not exceeding the capacity of the power supply network;
and in that said shredding chamber is limited by solid walls comprising:
a first section, substantially circular in shape and having a center on the axis of said main rotor;
a second section, which is connected with said first section, of a substantially circular shape, but with a greater radius than the previous one so as to increase the distance between the trajectory of the ends of the blades and the wall of the shredding chamber;
said movable element which, after having poured the materials to be treated into the shredding chamber, is arranged in such a way as to close said shredding chamber.

2. Machine for shredding inorganic waste, according to claim 1, characterized in that said first loading means comprise a first door which allows access to a loading area for the insertion of the materials to be treated, said loading area being limited by said one or more movable elements.

3. Machine for shredding inorganic waste, according to claim 2, characterized by the fact that said door is equipped with an electric lock designed to close automatically when the machine is in operation.

4. Machine for shredding inorganic waste, according to claim 2, characterized by the fact that inside said loading area there is a sensor able to detect the presence of materials to be treated.

5. Machine for shredding inorganic waste, according to claim 1, characterized in that a plurality of openings are made in the lower part of the wall of the shredding chamber, so as to obtain a sort of evacuation net , suitable for letting the shredded material through, acting as a sieve that allows only the fragments that have reached a predetermined size to pass.

6. Machine for shredding inorganic waste, according to claim 1, characterized in that said mobile element rotates around a pin and has the sectional shape of an arc of circumference in such a way as to accommodate the loaded material in its concavity and:
by rotating around said pin up to about 90°, it adjusts the flow of the materials to be poured into the underlying shredding chamber;
by rotating about 180° around said pin, it completely closes the passage towards the loading area, delimiting a large area, inside the shredding chamber, in which the materials projected by the centrifugal force, consequent to the strong rotation impressed by the main rotor, they tend to accumulate dynamically and, falling by gravity into the area below, they are hooked again by the knives of the main rotorto pass between the blades of the rake and undergo a new shredding, the formation of said dynamic accumulation by regulating the flow of material between the blades avoiding current absorption, by the motor, higher the capacity of the power supply network.

7. Machinefor shredding inorganic waste, according to claim 1, characterized in that said third discharge means, suitable for collecting the shredded materials, comprise a jacket conveyor, positioned outside the shredding chamber and in correspondence with said evacuation network, said conveyorbeing shaped in such a way as to receive the shredded material that comes out of the evacuation network and convey it to a collection area, where a basket is positioned.

8. Machinefor shredding inorganic waste, according to claim 1, characterized in that it provides for the presence of one or more sensors on said rake, suitable for identifying both its position with respect to the rotor main , and the presence of any loads interposed in the movement that excessively hinder rotation causing an increase in electrical power absorption that is not compatible with the capacity of the power supply network.

9. Method for limiting the power necessary to drive a shredding machinefor inorganic materials, according to claim 1, suitable for limiting the development of resistant couples, due to the shredding action, which require current absorption that exceeds the capacity from the power supply network, said limitation of the development of resistant couples, due to the shredding action, being implemented through a gradual pouring of the materials to be treated in said shredding chamber, allowing a start-up with no load or with minimum load of the motor, said gradualness being obtained by a gradual rotation of said movable element controlled by said fourth electronic means.

10. Method for limiting the power necessary to drive a shredding machine for inorganic materials, according to claim 1, suitable for limiting the development of resistant couples, due to the shredding action, which require current absorption that exceeds the capacity from the power supply network, said limitation of the development of resistant couples, due to the shredding action, is implemented through a retraction of the blades of said rake in case of excessive accumulated material between said knives of the rakeand the knives of said main rotor.
